(19) United States
(12) Patent Application Publication
(10) Pub. No.: US 2024/0288558 A1
(43) Pub. Date: Aug. 29, 2024

(54) OPTICAL MEASURING DEVICE AND METHOD

(71) Applicant: ams-OSRAM International GmbH, Regensburg (DE)

(72) Inventor: Reiner WINDISCH, Pettendorf (DE)

(21) Appl. No.: 18/570,135

(22) PCT Filed: Jun. 14, 2022
(86) PCT No.: PCT/EP2022/066081

§ 371 Date: Dec. 14, 2023

(30) Foreign Application Priority Data
Jun. 18, 2021 (DE) 10 2021 115 827.3

(51) Int. Cl. G01S 7/4911; G01S 7/4912; G01S 17/58; G01S 17/931

(52) U.S. Cl. CPC G01S 7/4911; G01S 7/4917; G01S 17/58; G01S 17/931

(57) ABSTRACT

An optical measuring device, in particular for a motor vehicle, includes a laser device designed to generate a single-mode laser beam whose frequency can be modulated and a controllable optical modulator designed for adjustable amplitude modulation of the frequency-modulated single-mode laser beam generated by the laser device. The measuring device also contains a detector device designed to receive part of the frequency-modulated single-mode laser beam generated by the laser device for superimposition with an amplitude- and frequency-modulated single-mode laser beam reflected by an object. An evaluation circuit is designed to transmit the signal superimposed by the detector device into the frequency domain and to determine the distance and speed of an object reflecting the single-mode laser beam.

### CROSS-REFERENCE TO RELATED APPLICATION

The present application is a U.S. National Stage Application of International Application PCT/EP2022/066081, filed Jun. 14, 2022, which claims the priority of German application DE 10 2021 115 827.3, filed Jun. 18, 2021; the entire disclosures of the above-listed applications are hereby incorporated by reference.

### FIELD

The present disclosure relates to an optical measuring device and a method for measuring an object.

### BACKGROUND

In addition to radar systems, LIDAR systems are also used today for distance measurements, particularly in the automotive sector. LIDAR stands for “Light Detection and Ranging” and refers to a method of using a light beam, in particular a laser beam, to detect and record the distance and, in some applications, the speed of an object. One possible approach is to emit a continuous laser beam whose light frequency is periodically modulated. The frequency rises over a certain period of time and then falls again, with the rise and/or fall being referred to as a chirp. By detecting a portion of the emitted laser light reflected by an object during such a chirp, the distance and also the relative speed can be detected using the optical Doppler effect.

However, different situations require several measurements to be taken, possibly with different parameters, in order to be able to distinguish between possible situations. For example, a single measurement with a continuous light that changes in frequency does not allow the relative speed of a moving object to be recorded. This would require a second measurement with a different frequency or a different gradient.

The different situations therefore require several measurements, so that a large number of measurements to generate a three-dimensional image with high resolution takes a long and unacceptable amount of time. For example, if a system is to cover a range of 200 m, the time required to cover twice the distance is approximately 1.3 μs. With an integration time of 0.7 μs, this results in a required time for the chirp of approximately 2 μs and therefore a minimum measurement duration of 3×2 μs. The latter results from the fact that several measurements are often necessary in order to clearly record the relative movement and to be able to assign it to several objects. If a new image is to be captured every 30 ms, the system can cover a maximum of 5000 points to generate such an image. However, typical requirements for cameras, particularly in the field of automotive applications, require significantly higher image resolutions, meaning that these cannot be easily achieved with such a system.

Although higher resolutions can be achieved by combining several such LIDAR systems and subsequently combining the low-resolution images generated in this way, the effort and hardware required for a high-resolution overall image increases significantly.

There is therefore a need to provide improved optical measuring devices and methods for measuring an object with which a higher resolution can be achieved in the same period of time.

### SUMMARY

This object is solved with the subject matter of the independent claims. Further developments and embodiments are the subject of the dependent claims.

To improve such a LIDAR system, the inventor now proposes integrating amplitude modulation into the same system in addition to frequency modulation. The required amplitude modulation can be performed both by the laser device itself and by a downstream modulator. With simultaneous frequency and amplitude modulation, detection can be carried out in a similar way to purely frequency-modulated systems, so that the amplitude modulation frequency results from the reflection of an object when evaluated in frequency space in addition to the difference frequency caused by the frequency modulation. From the phase position of this component and through a suitable evaluation of this information, both the distance of the object and its relative speed to the proposed optical measuring device can be determined by means of a single measurement. In particular, the phase of the detected reflected portion of the amplitude-modeled light can be calculated from the complex Fourier transformation using the real or imaginary part, and from this in turn the path. Due to the low frequency, the influence of the Doppler effect in the amplitude-modeled portion of the light signal is negligible.

In one aspect of the proposed principle, an optical measuring device is provided, in particular for a motor vehicle. This comprises a laser device which is designed to generate a single-mode laser beam whose frequency can be modulated. Furthermore, a controllable optical modulator is provided, which is used for adjustable amplitude modulation of the frequency-modulated single-mode laser beam generated by the laser device. The measuring device also comprises a detector device for receiving a portion of the frequency-modulated single-mode laser beam generated by the laser device and a portion of an amplitude- and frequency-modulated single-mode laser beam reflected by an object. The detector device is designed to superimpose the received signals and thus effect a frequency conversion to a lower intermediate frequency. In this respect, the detector device acts as a frequency mixer, with the frequency-modulated single-mode laser beam component generated by the laser device serving as a local oscillator signal. The resulting mixed signal has a frequency that can be represented as a difference frequency.

Finally, the optical measuring device comprises an evaluation circuit which is designed to transmit the signal superimposed by the detector device into the frequency domain and subsequently determine the distance and speed of an object which at least partially reflects the single-mode laser beam back into the detector.

In this way, an optical measuring device is created that uses both an amplitude-modulated and a frequency-modulated part of a laser beam to obtain information about the distance and relative speed of an object from the reflected part of the laser beam. In contrast to conventional systems, this significantly reduces the measurement time. In particular, the additional amplitude modulation supplements reliable and fast distance measurement, even at close range, so that the weaknesses of optical measuring devices based purely on frequency-modulated systems can be combined.

The proposed combination is cost-effective and can be realized with only a small additional space requirement. Another advantage is that only a limited range of relative velocity is realistic, especially for applications of the optical measuring device in motor vehicles. This results in a rather small resulting Doppler shift, so that the combined measuring system, which evaluates both frequency and amplitude modulation, can check its own function itself due to the simultaneous use of two common measuring methods and thus detect errors itself to a limited extent.

For the purpose of this application, a motor vehicle is a means of transportation that moves by means of a drive. This includes, inter alia, any motor vehicle for road transportation, but also vehicles for rail and, in particular, air transportation. It should also be mentioned in this regard that the present disclosure is not limited to motor vehicles, but can also be used in other applications, for example for stationary radar measurements for speed detection.

In one aspect, the controllable optical modulator comprises a controllable electro-optical modulator. In particular, this can be formed from a group based on the modulation of the transmission or absorption behavior of a suitable material. For example, electro-optical modulators based on the Franz-Keldysh effect or the quantum-confined Stark effect are proposed for this purpose. Alternatively, the controllable optical modulator can also have a Mach-Zehnder modulator.

Some aspects also deal with an optical isolator that is connected upstream of the controllable optical modulator. Such an optical isolator is used to suppress feedback of a portion of the single-mode laser beam into the laser device when amplitude modulation is switched on. This prevents a portion of light from being reflected back into the laser device due to the operation of the controllable optical modulator, where it leads to a change in the emitted laser light power. In a further aspect, a beam splitter can also be provided, which is arranged in the beam path between the laser device and the controllable optical modulator and is designed to direct part of the frequency-modulated single-mode beam generated by the laser device onto the detector device. The part of the frequency-modulated single-mode beam generated by the laser device serves as a so-called local oscillator signal for the frequency conversion with the detected light component reflected by the object. In this context, it may be provided that the detector device comprises a filter which is substantially opaque, in particular for frequencies outside the laser light including the frequency modulation provided. This allows the sensitivity of the detector device to be improved in some implementations.

In a further aspect, the optical measuring device also comprises a light optic which is connected downstream of the controllable optical modulator in a beam path. The light optics are designed to detect the light reflected by the object from the frequency- and amplitude-modulated single-mode laser beam and direct it onto the detector device. In one aspect, the light optics comprise one or more lenses or mirror systems which, on the one hand, emit the light coming from the modulator to the outside and, on the other hand, direct a portion reflected by an object onto the detector device. The light optics can comprise movable mirrors, for example MEMS mirrors, so that a scanner function of the optical measuring device can be realized. The mirrors of the light optics would be designed in such a way that they are controllably rotatable or displaceable by a certain angle, so that the optical measuring device can perform scanning or scanning in a predetermined angular range.

A further aspect of the proposed principle concerns the coherence length of the laser device and the generated single-mode laser beam. This is selected so that it corresponds to at least twice the distance to be measured, so that coherence is maintained by the frequency modulation when an object is detected within the maximum distance. A further element with a local oscillator can be used to control, monitor and adjust the linearity of the frequency modulation. This can control the laser device accordingly via a delay line in order to generate the frequency-modulated laser light.

In another aspect, it is proposed that the amplitude modulation is performed via a sinusoidal amplitude modulation signal. In this context, an amplitude modulation signal is the signal applied to the modulator to cause modulation of the amplitude of the laser light. The amplitude modulation frequency is the frequency at which the amplitude is modulated, the modulation depth or the deviation indicates the difference between the minimum and maximum amplitude during a period of the amplitude modulation frequency.

This means that the amplitude changes sinusoidally with the amplitude modulation frequency, which (ideally) becomes visible in the frequency spectrum in a later evaluation by means of a single frequency. However, depending on the specification, other types of modulation can also be realized, for example a rectangular shape of the modulation signal or a triangular or sawtooth shape.

One problem with a frequency-modulated measurement according to the proposed principle is the required continuity of the laser light to be emitted. Accordingly, it is proposed that the controllable optical modulator generates an amplitude modulation, but that the amplitude modulation deviation is only in the range from 2% to 60% and in particular in the range from 5% to 30%. This means that even during amplitude modulation, sufficient light from a reflected object can still reach the detector where it can be suitably evaluated.

In addition, the amplitude modulation deviation should be selected in such a way that it can still be detected and meaningfully evaluated by the subsequent evaluation circuit after a frequency conversion. Modulation depths in the range of 5%, for example in the range of 2% to 10%, have proven to be particularly effective and at the same time allow continuous radiation for the actual frequency-modulated distance measurement.

In an aspect, an intensity of the portion of the frequency modulated single mode laser beam generated by the laser device is higher than a maximum amplitude of the amplitude and frequency modulated laser beam reflected from the object and detected by the detector. This results in sufficient intensity of the light acting as an oscillator signal in the detector arrangement, thus achieving linear conversion and mixing. An unclean frequency spectrum, which can occur particularly at intensities smaller than the maximum amplitude of the received reflected signal, is thus avoided.

In a further aspect, the evaluation circuit is designed for a complex Fourier transformation of the signal superimposed by the detector device. This is useful because information about the light propagation time is obtained in the phase of the reflected light, so that a distance to the object can be determined from a real or imaginary part of this phase, in particular the phase of the amplitude-modeled component. At the same time, a Fourier transformation is used to obtain information about the frequency-modulated component, i.e. a frequency shift due to propagation time. With a stationary object or no relative movement to each other, these two components should be the same, so that on the one hand an exact distance determination and on the other hand a possible error detection in the detection or evaluation can be recognized. In the case of an additional relative movement, the time-related frequency shift is also Doppler-shifted, so that both the distance and the relative speed can be determined using the joint information from the evaluation of the amplitude-modulated component. This makes it possible to determine both the distance and the relative velocity during the duration of a single frequency modulation, i.e. a single chirp of the laser device.

In another aspect, a frequency for the amplitude modulation of the controllable optical modulator is selected to be greater than a difference frequency. The latter results from a frequency of the amplitude and frequency modulated laser beam received by the detector device and reflected by the object at a time and the portion of the pure frequency modulated laser beam generated by the laser device received in the detector device at that time. In other words, the frequency for the amplitude modulation is greater than the difference frequency resulting from an evaluation based on the distance to the object by means of the phase position and the frequency modulation of the emitted light. In one aspect, the frequency modulation can be in the range from a few 100 kHz to a few megahertz.

In such a case, the amplitude modulation of the controllable optical modulator would be greater than the difference frequency described above, which is the result of determining the frequency-modulated reflected signal. In some examples, the amplitude modulation may be greater than 100 kHz and also greater than 1 MHz. In another aspect, the duration of one pass of a frequency modulation is more than twice a light propagation time of a maximum predetermined path length. This ensures that the frequency modulation is complete. The duration of a chirp can also be selected such that it is, for example, exactly twice or four times a light propagation time of a maximum predetermined path length.

Another aspect deals with various implementations that are suitable for covering special cases when measuring the distance of one or more objects. These aspects are based on the fact that the frequency superimposition of both the frequency-modulated and the amplitude-modulated components results in the possibility that the respective results are very close to each other and thus either cannot be resolved sufficiently well separately by the Fourier transformation or a distinction between them becomes difficult. However, with a higher amplitude modulation frequency as described above, the phase shift of the detected light becomes greater than 2 π, i.e. more than 360°, even at shorter distances, so that no clear distance measurement is possible based on the phase position. To circumvent this problem, it is proposed in some aspects to design the controllable optical modulator in such a way that a frequency of the amplitude modulation is changed during the duration of a cycle of a frequency modulation. For example, the frequency of the amplitude modulation can be changed after about half of the duration of a frequency modulation, i.e. after half of a chirp. The two different amplitude modulation frequencies now solve the above-mentioned problem of ambiguity at long distances.

In this context, it is useful to design the evaluation circuit in such a way that it performs a first Fourier transformation during the duration of the frequency of the amplitude modulation and a corresponding second Fourier transformation during the duration of the changed frequency of the amplitude modulation. The distance and the relative speed of the object to the measuring device can now be determined on the basis of these two Fourier transformations.

By means of the optical measuring device proposed here, in particular with the evaluation circuit which operates on the basis of Fourier transforms, it is however also possible to form the control of the controllable optical modulator for amplitude modulation of the frequency-modulated laser beam generated by the laser device in such a way that the frequencies of the amplitude modulation are composed of a first modulation signal and a second modulation signal which differs therefrom at least in frequency. In other words, the amplitude modulation is thus performed by the controllable modulator in such a way that the amplitude of the incident laser beam is changed not only with one amplitude modulation frequency, but with a superposition of two or more such amplitude modulation frequencies. These additional modulation signals and modulation frequencies are superimposed and can be resolved again in the evaluation circuit by the Fourier transformation within the frequency range.

Accordingly, the phases can be determined individually and thus the actual distance can be inferred in a similar way to two consecutive measurements. In addition, this aspect has the advantage that the entire chirp of the emitted laser beam can be used to determine the difference frequency from the frequency-modulated component.

The inventor also proposes an improved method for measuring objects and determining their distance and relative speed, which makes use of the principle presented here. In a first step, this comprises generating a frequency-modulated laser beam, in particular a single-mode laser beam. A small part of the frequency-modulated laser beam is then decoupled. The remaining, significantly larger part of the frequency-modulated laser beam is modulated in its amplitude and thus in its intensity with an amplitude modulation signal. The frequency and amplitude modulated laser beam is emitted, possibly reflected by an object. A portion of the frequency- and amplitude-modulated laser beam and the previous portion of the frequency-modulated laser beam are received and superimposed together. This creates a beat whose frequency results from the difference between the frequency-modulated components of the part and the reflected part of the laser beam.

The beat is recorded and then evaluated in various ways as explained above. For example, a complex Fourier transformation can be applied to the detected signal in one aspect. A phase length of a component is then evaluated at a frequency which corresponds to an amplitude modulation frequency of the amplitude modulation signal.

In another aspect, a complex Fourier transform is generated from the acquired signal. This comprises a first frequency component that substantially corresponds to a frequency of the beat and at least one second frequency component that substantially corresponds to an amplitude modulation frequency of the amplitude modulation signal. The result of the Fourier transformation is then further evaluated by calculating the distance from a phase position of the signal with the second frequency component. Alternatively or additionally, the distance can also be calculated from the signal with the first frequency component. The results of such a calculation are used, for example, to carry out plausibility checks, to estimate weather and weather conditions, to carry out internal error analysis and much more.

In this context, a relative velocity can also be calculated from the signal with the first frequency component on the basis of a phase position of the signal with the second frequency component. The method thus has the advantage that, in contrast to purely frequency-modulated methods, only one measurement is required to determine distance and relative velocity. In some aspects, it is provided that the amplitude modulation frequency is selected such that it is greater than a possible maximum expected value of the first frequency component. This aspect is particularly useful in order to obtain a better separation of the individual components in the frequency spectrum after the Fourier transformation.

Another aspect deals with the type of frequency modulation. In one aspect, a modulation frequency of the frequency modulated laser beam increases from a first frequency value to a second frequency value, in particular linearly over a period of time. This time period is also referred to as chirp and it is greater than a predetermined value corresponding to a maximum measurement distance. With the method according to the proposed principle, a complete measurement can be carried out to detect the distance and the relative speed during a single chirp. In this respect, the reception and generation of the beat is carried out during the chirp.

A further aspect concerns the possibility of also using the method to generate “images” in which a predefined area is scanned. Accordingly, in some aspects, the method comprises the step of deflecting the frequency and amplitude modulated laser beam by a defined amount. The deflection is performed at regular times, in particular at times when no reception is taking place. In other words, the means for deflecting the laser beam are always changed when no measurement is taking place. In this way, a larger area can be scanned.

In order to reduce interference and false measurement results, it is advisable to design a coherence length of the generated single-mode laser beam so that it corresponds to at least twice the distance to an object reflecting the single-mode laser beam.

Another aspect concerns the amplitude modulation signal. In some situations, a single amplitude modulated component cannot provide correct or unambiguous results. It is therefore useful to change an amplitude modulation frequency during the chirp, so that when a frequency spectrum is evaluated and generated, several signal components are present that correspond to the different amplitude modulation frequencies. In an alternative embodiment, the amplitude modulation signal is composed of a first component with a first frequency and at least one second component with a second frequency different from the first frequency.

### BRIEF DESCRIPTION OF THE DRAWINGS

Further aspects and embodiments of the present disclosure will become apparent with reference to the various embodiments and examples described in detail in connection with the accompanying drawings.

FIG. 1 shows a schematic representation of an optical measuring device based on the proposed principle;

FIG. 2 shows frequency-time diagrams in the subfigures, which serve to explain various aspects of distance and speed measurement;

FIG. 3 shows a frequency spectrum of a distance measurement result;

FIGS. 4A and 4B are illustrations of an intensity and frequency spectrum respectively to explain the measurement results of a device according to the proposed principle;

FIG. 5 shows schematic representations of amplitude modulation signals with different frequencies;

FIG. 6 shows an embodiment of a method for measuring the distance of an object or its relative speed according to the proposed principle.

### DETAILED DESCRIPTION

The following embodiments and examples show various aspects and their combinations according to the proposed principle. The embodiments and examples are not always to scale. Likewise, various elements may be shown enlarged or reduced in size in order to emphasize individual aspects. It is understood that the individual aspects and features of the embodiments and examples shown in the figures can be readily combined with each other without affecting principles of the present disclosure. Some aspects have a regular structure or shape. It should be noted that slight deviations from the ideal shape may occur in practice without, however, contradicting the inventive concept.

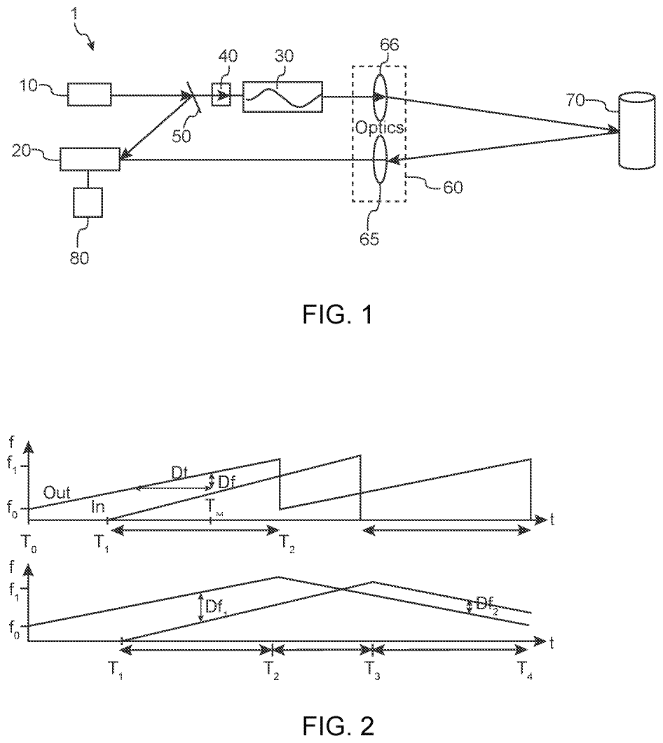

FIG. 1 shows a schematic representation of an optical measuring device based on the proposed principle. The optical measuring device comprises a laser device 10, which is designed to generate and emit a frequency-modulated single-mode laser beam. The laser device 10 is designed in particular as a semiconductor laser, for example as an edge-emitting or vertically emitting semiconductor laser. These allow adjustable light intensities to be generated permanently.

A beam splitter 50 is now arranged in the beam path of the laser device 10, which diverts part of the frequency-modulated laser light emitted by the laser device to a detector 20. The detector 20 can be constructed on the same substrate as the laser device 10, so that the optical measuring device can be realized in a particularly space-saving and small way. The beam splitter 50 is semi-transparent, so that the greater proportion of the light emitted by the laser device 10 in the beam path is fed to a modulator 30. In the embodiment example, this proportion is more than 90% and can in particular be in the range of 95% to 99%. In this respect, only a small proportion is split out by the beam splitter, whereby a possible reflected proportion is even smaller due to the losses on the measurement path. The power in this so-called local oscillator signal effectively leads to an amplification of the received reflected signal of the frequency modulation. In practice, it is mainly limited by the linear detection range of the detector used, which should not be driven to saturation.

The modulator 30 is designed as an electro-optical modulator, which produces a controllable modulation of the absorption of the laser light introduced. When using an electro-optical modulator, which generates a modulation of the absorption or transmission, an optical isolator 40 is additionally provided in the beam path between the beam splitter 50 and the modulator 30 according to the proposed principle. The optical isolator 40 also transmits the laser light coming from the laser device and transmitted by the beam splitter 50 or passes it on to the modulator 30. However, due to modulation by means of absorption, some of the light can be reflected back towards the laser device 10, so that the optical isolator is provided for this purpose. This suppresses the light reflected by the modulator 30 so that the portion reflected back does not fall into the laser device, where it can lead to an undesired change in intensity. Alternatively, the beam splitter 50 can also assume this function, so that the portion reflected back into the device is negligible.

An electro-optical modulator that generates a change in intensity and thus amplitude modulation by changing the transmission or absorption behavior is realized, for example, in a modulator that uses the Franz-Keldysh effect or the quantum-confined Stark effect. Both are based on changing the absorption in the material of the electro-optical modulator by generating an external electric field. Alternatively, a modulator based on the Mach Zehnder principle can be used, which generates its intensity modulation and thus the amplitude modulation through a phase shift between two interferometers. The phase shift can in turn be adjusted accordingly by applying a voltage to an electro-optical element. The advantage of this arrangement is a significantly lower or negligible back reflection, so that the additional optical isolator can be dispensed with here.

In addition to a linear frequency-modulated single-mode laser, the laser device 10 shown here also comprises an additional component that operates as a local oscillator for the device 10. This comprises a delay line and is used to control, monitor and adjust the linearity of the frequency modulation of the signal emitted by the laser device 10.

An optical arrangement 60 is now provided in the output of the optical modulator 30, which has one or more lenses, mirrors or other optical elements. In the embodiment shown here, the optical system 60 comprises one or more mirrors 66 which direct the laser light in a controllable manner onto the object 70 located at a distance from the optical measuring device. For example, MEMS or other mirrors can be used for this purpose, so that scanning or scanning of an area to be monitored by the optical measuring device is possible with the optical device and continuous operation. In addition to lenses and mirrors 66 for the output side, the optical measuring device also comprises corresponding lens systems 65 for a light component reflected back from the object 70. This falls into the optical arrangement 60 and is then directed onto the measuring range of the detector device 20.

FIG. 2 shows the effect of this arrangement without the additional amplitude modulation by the modulator 30. The upper part of the figure is an example of a measurement on a stationary object. The output frequency of the output signal, designated here as OUT, increases linearly from an initial frequency f0 to an end frequency f1 during a period of time TO up to a point in time T2. This period between T0 and T2 is referred to as the chirp. It then falls back to the output frequency f0 at time T2 (simplified here) and the increase begins again.

The laser light emitted by the laser device strikes an object 70 at some distance and is reflected back by it. The duration of the reflected light In is denoted by Dt and is constant for a stationary object. Accordingly, a specific output frequency of the frequency-modulated laser light and a different frequency of the reflected light that falls on the detector result at a measurement time Tm. The detector arrangement shown in FIG. 1 now uses the emitted laser light at this measurement time Tm and superimposes this with the back-reflected component. The superimposition corresponds to a mixing process so that a beat occurs, the difference frequency of which is designated Df. In other words, the beat frequency corresponds to the difference frequency Df and this in turn is proportional to the difference in the light beams and therefore to the distance.

The beat frequency Df generated can be measured by feeding the signal generated by the detector to an evaluation circuit 80, which directly detects the difference frequency Df by means of a Fourier transformation, i.e. a conversion into frequency space. If the intensity of the component deflected into the detector by the beam splitter 50 is sufficiently strong, linearity of the beat is ensured on the one hand and, on the other hand, background light and other interference components can be filtered out in a suitable manner, since these are not coherent with the emitted and reflected laser radiation. In some aspects, the detector device may further comprise wave or frequency selective filters for this purpose in order to further improve the signal-to-noise ratio. Similarly, the detection unit may comprise a pair of differential detectors with an upstream beam splitter.

The lower part of FIG. 2 shows the situation with an object moving relative to the optical measuring device. The relative movement leads to a Doppler effect and thus a change in the measured difference frequency. In particular, it is not possible in this case to use a single measurement to decide whether the object is moving towards or away from the optical measuring device, or whether it is moving at all and is not simply a relatively stationary object at a greater distance. Accordingly, two measurements are necessary, as carried out here during the times T1 to T2 and T3 to T4.

During the first measurement window between the times T1 and T2, a difference frequency Df1 results, which is slightly larger due to the Doppler shift of the moving object. During the second measurement period between the times T3 and T4, a correspondingly smaller difference frequency Df2 results. The distance to the moving object can thus be determined by the sum of these difference frequencies Df1+Df2, the speed results from the difference Df1−Df2 of the respective values.

As can be seen from both sub-figures, the measurement duration, especially for moving objects, is significantly longer than the corresponding measurement duration for stationary or non-moving objects. This is due to the fact that a second run with frequency modulation, i.e. a second chirp, is necessary for a velocity measurement, which is carried out here from the higher frequency f1 back to the fundamental frequency f0 as shown. In practice, this results in approximately double the measurement time for the detection of distance and speed.

In the event that two or more objects are illuminated at the same time, and therefore several difference frequencies occur in the measurement, further chirps are also necessary, particularly with a different duration, in order to achieve clear results and to be able to assign the distances and the respective relative speeds to the objects. The background to this is that it is generally difficult to determine the correct assignment of the frequencies to the objects for every two measured difference frequencies. For example, the same difference frequencies with different chirps can indicate two static objects. However, the same result is also obtained if the objects move at the same distance but at opposite relative speeds. This makes the third chirp with a different measurement time necessary if systems based purely on frequency modulation are used.

The design of an optical measuring device according to the present disclosure and the simultaneous detection of a frequency-modulated reflected component and an amplitude-modulated reflected component allow the phase of the incident amplitude-modulated light to be calculated in an evaluation after a Fourier transformation of these detected components. The phase in turn gives the path of the light, and due to the low frequency, the influence of a Doppler effect is negligible for the amplitude-modeled component due to the relative speed of the object to the measuring device. On the other hand, the frequency-modulated part contains both the distance information and information on the relative speed. If the distance is already extracted by evaluating the amplitude-modulated component, this can be used to derive the relative speed via the frequency-modulated component and its evaluation. This makes it possible to make a statement about the relative speed and distance of a detected object during a single measurement period, i.e. a single chirp of the frequency-modulated laser light emitted by the laser device.

The proposed detector arrangement with the superposition of the back-reflected portion of the light from the laser device 10 and the portion of the laser light that enters the detector 20 directly detects the amplitude-modulated portion heterodyne. This also makes this portion relatively insensitive to ambient light and can therefore also be used for medium and long distances in the area of motor vehicles. In this respect, the proposed principle can also be regarded as an extended heterodyne method for amplitude-modulated laser measurement devices.

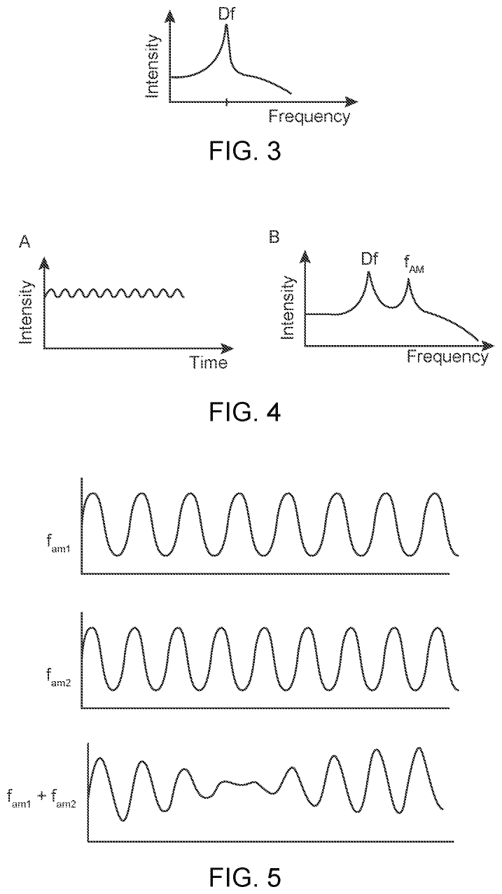

FIGS. 3, 4A and 4B schematically show the results of the evaluation circuit after a Fourier transformation for the various situations. FIG. 3 is a representation of a determined differential frequency in the evaluation circuit, which results after a part of the laser light is reflected by an object. In this measurement, there is initially no amplitude modulation of the signal emitted by the laser device, so that the measurement generates a single difference frequency Df at a frequency that can be easily determined by the Fourier transformation.

FIG. 4A, however, shows the modulation frequency and the modulation deviation for the amplitude modulation of a frequency-modulated signal. As can be seen, the intensity and thus the amplitude of the emitted signal fluctuates over time at an essentially constant frequency. This frequency is also referred to as the amplitude modulation frequency fAM and is generally greater than the expected difference frequency Df, which can reasonably result from the beat between the unreflected frequency-modulated laser light and the reflected frequency-modulated laser light. However, the modulation deviation is only a few percent. When laser light is reflected from the object and the amplitude and frequency modulated component is detected at the detector, an additional beat is measured at this frequency, which corresponds to the amplitude modulation frequency fAM.

Due to the evaluation circuit and the Fourier transformation carried out, this amplitude modulation frequency fAM appears as an additional frequency component, as shown in FIG. 4B. Although the modulation frequency fAM is known in this method and therefore does not contain any further usable information in itself, the information about the light propagation time is contained in the phase of this component. In turn, the distance of the object can be deduced from the light propagation time. For this purpose, the evaluation circuit is designed as a Fourier transformation that contains the real and imaginary parts at the amplitude modulation frequency fAM.

The distance to the object determined in this way via the phase position of the signal with the frequency fAM also corresponds to the runtime-related frequency shift due to the frequency chirp and thus Df in the case of a static, i.e. not relatively moving object. If the two values are the same, a static object can therefore be assumed. However, if the results are different, there is an additional Doppler shift due to a relative movement between the optical measuring device and the object. Due to the known distance based on the evaluation of the phase position at the amplitude modulation frequency fAM, the magnitude of the Doppler shift is now determined from the measurement of the time-of-flight-related frequency shift and thus the relative velocity is inferred. The proposed principle makes it possible to detect both the distance and the relative velocity via a single frequency-modulated chirp of the emitted laser light, which is also amplitude-modulated.

In some situations, for example at greater distances, the phase shift in the evaluation of the amplitude-modulated component can be greater than 2π and therefore greater than 360°. It can also happen that both the difference frequency Df due to the frequency shift and the amplitude modulation frequency fAM are relatively close to each other, so that they can no longer be clearly resolved separately even after a Fourier transformation and post-processing. The latter problem can be solved by selecting the amplitude modulation frequency fAM in such a way that in practice it cannot occur in the range of possible difference frequencies when evaluating the frequency-modulated component. This is exploited by the fact that the duration of the chirp, i.e. the passage of a frequency modulation stroke, is significantly longer than the light propagation time to the maximum range and back. If a frequency range of a few 100 kHz to a few megahertz is used for frequency modulation at the same time, the difference frequency is at most in this range, but usually significantly smaller than the selected frequency range. A superimposition of the amplitude modulation frequency with the difference frequency, for example, is excluded if the amplitude modulation frequency fAM is greater than the maximum possible difference frequency. For example, if the frequency modulation deviation is 500 kHz, the amplitude modulation frequency can be 900 kHz or even 1.1 MHz or 1.2 MHz. It should be mentioned at this point that the frequency of the frequency modulation and the frequency of the amplitude modulation should be as far as possible independent of the divider and in particular should not be an integer or half-integer multiple. This prevents faulty detection due to harmonic components.

A higher amplitude modulation of several megahertz, for example, is accompanied by a lower distance measurement, above which the phase shift of the reflected light component becomes greater than 2π and therefore no clear distance measurement is possible. There are also several solutions to this problem.

For example, two sequential measurements can be carried out with slightly different amplitude modulation frequencies fAM1 and fAM2, which in particular can be independent of the divider. This achieves unambiguity over a wide range of distances. In one embodiment, the amplitude modulation frequency is switched back and forth between two values for this purpose, with the switchover point conveniently occurring approximately after half the duration of a frequency modulation stroke and thus a chirp.

However, it is also possible to apply two signals with slightly different amplitude modulation frequencies to the optical modulator in order to generate an amplitude modulation that can be varied over time. FIG. 5 shows a corresponding embodiment in which a first modulation signal with the frequency fAM1 is applied to the optical modulator on the one hand and a second modulation signal with a slightly shifted frequency fAM2 on the other. This results in an overall signal that is shown in the third partial image of FIG. 5. In this respect, the electro-optical modulator can be controlled with any modulation signals so that different frequencies can be modulated simultaneously. Since the amplitude modulation is carried out by an electronically freely controllable modulator, it is technically possible to generate any temporal progressions, and thus modulation can also be carried out with both frequencies simultaneously.

When detecting the back-reflected light signal with this type of amplitude modulation, the two modulation frequencies fAM1 and fAM2 can be resolved again by the Fourier transformation in the evaluation circuit. They would appear in the frequency spectrum as additional lines next to the difference frequency Df. The distance is then deduced from the respective phase positions, regardless of whether the phase position is greater than 2π.

On the one hand, this method makes it possible to perform a back calculation to the actual distance in a similar way to two consecutive amplitude modulation signals and also to use the entire duration of a chirp to determine the difference frequency from the frequency-modulated components. It is advisable to select the two amplitude modulation frequencies so that they are greater than the expected difference frequencies when evaluating the frequency-modulated component. On the other hand, a sequential sequence of two frequencies is appropriate if it is not possible to select the amplitude modulation frequency so high that superimposition with the difference frequency from the frequency-modulated components is excluded. In this case, the sectional Fourier transformation with two different amplitude modulation frequencies has the advantage that the difference frequency can be clearly distinguished from the amplitude modulation frequency in at least one of the sections and can therefore be clearly measured.

The system proposed here can also be used equally in different weather conditions. In the case of very strongly light-scattering conditions, for example in fog, there is a risk that the part of the measurement based on the evaluation of the amplitude-modulated component of the reflected signal will be falsified. In such conditions, the optical measuring device can deactivate the optical modulator and the measurement can be carried out purely on the basis of the frequency-modulated component with several different, successive chirps with a correspondingly longer measurement duration. The amplitude is not modulated in this case. Conversely, a comparison step between the results of the evaluation of the amplitude-modulated and frequency-modulated components can also be used to easily detect an evaluation of the weather conditions or an incorrect measurement due to fog or similar. The system therefore has the further advantage that the simultaneous measurement with different methods enables a kind of self-check of the system, as only a limited Doppler shift is possible at realistic speeds.

If the scanning speed in a downstream optical lens system is variable, such as in a mechanical mirror or a non-resonant MEMS mirror, the scanning speed can be adapted accordingly to the longer measurement duration due to the multiple chirp. If the scanning speed cannot be changed, e.g. in a resonant MEMS mirror, the required measurements can also be carried out in successive scans.

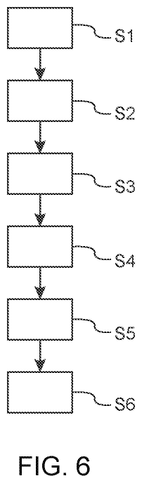

Finally, FIG. 6 shows individual steps of a process that implements the proposed principle. In step S1, a frequency-modulated laser beam is generated whose coherence length is selected so that it exceeds the maximum measuring distance by at least twice. The frequency deviation of the frequency-simulated laser beam is in the range of several 100 kHz to about one or 2 MHz. The duration of such a frequency modulation, i.e. the sweep from the lowest frequency to the highest frequency, is referred to as a chip and amounts to a few microseconds.

The frequency-modulated laser light generated in this way is divided into two parts in a subsequent step S2, with a smaller part serving as a local oscillator-like signal for subsequent detection. The much larger part of the frequency-modulated split laser light is now modulated in its amplitude, i.e. in its intensity. This amplitude modulation involves setting the modulation deviation on the one hand and the amplitude modulation frequency on the other. During amplitude modulation in step S3, the modulation deviation is only a few percent to between one and 10%. As a result, the subsequent detection of the frequency-modulated signal is not significantly impaired. At the same time, the amplitude modulation can still be detected and clearly separated from a background signal.

However, the amplitude modulation frequency fAM is selected to be significantly higher than the expected difference frequency, which results from the maximum measuring distance and the resulting time difference and therefore the difference frequency. In practice, the amplitude modulation frequency is selected slightly higher than the frequency deviation of the frequency modulation. For example, the amplitude modulation frequency can be 900 kHz if the frequency modulation is only in the range of 400 or 500 kHz. Ideally, the amplitude modulation frequency and the frequency deviation of the frequency modulation should preferably be divisors of each other, in particular not whole-sided or half-sided multiples. Although the frequency deviation of the modulation depends on the distance to the object, a previous measurement and any objects detected there or the direction and speed of these objects can be taken into account in order to adjust the frequency deviation if necessary.

In step S4, the amplitude- and frequency-modulated laser light is directed onto an object and at least partially reflected by it. The reflected part is received and superimposed with the previously separated part of the pure frequency-modulated laser light. This produces an oscillation in step S5, which results from the superposition of the reflected laser light and the laser light that was initially split out. Due to the propagation time of the laser beam to the object and back again, the frequency of the received reflected laser light is slightly different to the frequency of the frequency-modulated laser light that is split out. The resulting beat thus generates a difference frequency from which the distance can be derived directly.

It is also possible to evaluate the phase position of the amplitude-modeled component in step S5 and thus obtain information about the distance. For this purpose, the superimposed signals and thus the beat are subjected to a Fourier transformation and thus transformed from the time domain into the frequency domain. This results in several lines in the frequency domain, one of which represents the aforementioned difference frequency, while the other essentially represents the amplitude modulation frequency.

The Fourier transformation is complex, so that the phase position of the amplitude-modeled component, i.e. the signal at the amplitude modulation frequency, contains information about the distance to the object. Accordingly, the distance to the reflecting object can also be deduced by evaluating the phase position.

This information, in particular the information from the phase position, is now used in step S6 to obtain information about the relative velocity. If it is a stationary object, i.e. an object whose relative velocity essentially disappears, the difference frequency obtained from the beat and the distance determined from it should match the corresponding distance determined from the phase position. In this way, the same result is obtained from two different measurement methods (provided that the phase position remains smaller than 2π).

However, if a relative speed is present, the difference frequency changes due to the relative speed and becomes correspondingly larger or smaller. The difference compared to the phase position and the distance can therefore be used to infer the relative speed of the object and, in particular, the direction of movement. This approach, carried out in step S6, makes it possible to determine both the distance to a reflecting object and its relative speed with a single measurement during a single run or chirp of the frequency modulation.

Alternatively, amplitude modulation can also be performed in step S3 with several superimposed amplitude modulation signals and, in particular, with several amplitude modulation frequencies. Overall, it is possible to perform amplitude modulation in different ways, i.e. also as triangular or rectangular modulation. With these types of amplitude modulation, there are several amplitude modulation frequencies that can be represented as a Fourier series and lead to several periodic signals in the spectrum. This makes it possible to clearly resolve any interference or phase positions, even if these have more than 360° and therefore a complete revolution, as is possible at greater distances. After a Fourier transformation, the amplitude modulation signals and the different amplitude modulation frequencies form a more complex spectrum with several individual lines in addition to the already known reference frequency. However, since their amplitude modulation frequencies are known, it is possible to obtain the necessary information on distance from the phase position of the complex value and thus again together with the result of the difference frequency. The relative velocity can be deduced from the frequency-modulated component.

### REFERENCE LIST

1 Optical measuring device
10 Laser device
20 Detector device
30 optical modulator
40 optical isolator
50 Beam splitter
60 Optical arrangement
65, 66 Lens system
70 Object
80 Evaluation circuit
Df Difference frequency
Df1, Df2 Difference frequency
Dt Difference duration
T1, T2 Times
T3, T4 Times
TM Measurement time
fAM amplitude modulation signal

1. An optical measuring device for a motor vehicle, comprising:
a laser device designed to generate a single-mode laser beam whose frequency can be modulated;
a controllable optical modulator designed for an adjustable amplitude modulation of the frequency-modulated single-mode laser beam generated by the laser device;
a detector device designed to receive a portion of the frequency-modulated single-mode laser beam generated by the laser device for superposition with an amplitude- and frequency-modulated single-mode laser beam reflected by an object;
an evaluation circuit for transmitting the signal superimposed by the detector device into the frequency domain and determining the distance and speed of an object reflecting the single-mode laser beam;
wherein the controllable optical modulator is designed to change a frequency of the amplitude modulation during a duration of a cycle of a frequency modulation, in particular after half of the duration,
wherein the optical measuring device further comprises a beam splitter which is arranged in the beam path between the laser device and the controllable optical modulator and is designed to direct a part of the frequency-modulated single-mode laser beam generated by the laser device onto the detector device as a local oscillator signal, and
wherein an intensity of the portion of the frequency-modulated single-mode laser beam generated by the laser device is higher than a maximum detected amplitude of the amplitude- and frequency-modulated single-mode laser beam reflected from the object.

2. The optical measuring device according to claim 1, wherein the controllable optical modulator comprises a controllable electro-optical modulator selected from a group operating on the basis of the Franz-Keldysh effect or the Quantum-Confined-Stark effect; or wherein the controllable optical modulator comprises a Mach-Zehnder modulator.

3. The optical measuring device according to claim 1, further comprising an optical isolator which is connected upstream of the controllable optical modulator and of a beam splitter, and is designed to suppress feedback of a portion of the single-mode laser beam into the laser device.

4. The optical measuring device according to claim 1, further comprising a light optics which is arranged downstream of the controllable optical modulator in a beam path and is configured to direct a portion of the frequency- and amplitude-modulated single-mode laser beam reflected by the object onto the detector device.

5. The optical measuring device according to claim 1, wherein a coherence length of the single-mode laser beam generated by the laser device corresponds to at least twice a distance to the object reflecting the single-mode laser beam.

6. The optical measuring device according to claim 1, wherein the controllable optical modulator is designed to generate a sinusoidal amplitude modulation with a modulation depth in the range from 2% to 60%.

7-8. (canceled)

9. The optical measuring device according to claim 1, wherein the evaluation circuit is designed for a complex Fourier transformation of the signal superimposed by the detector device.

10. The optical measuring apparatus according to claim 1, wherein a frequency for amplitude modulation of the controllable optical modulator is greater than a difference frequency resulting from a frequency of the amplitude and frequency modulated single-mode laser beam reflected from an object received by the detecting device at a time and the portion of the frequency modulated single-mode laser beam generated by the laser device received in the detecting device at said time.

11. The optical measuring device according to claim 1, wherein the frequency modulation is in the range of see a few 100 kHz to a few MHz and/or the amplitude modulation of the controllable optical modulator is greater than 1 MHz.

12. The optical measuring device according to claim 1, wherein the duration of one cycle of a frequency modulation is greater than twice a light propagation time of a maximum predetermined path length.

13. The optical measuring apparatus according to claim 1, wherein the evaluation circuit is adapted to determine a distance and relative velocity of an object based on a frequency modulation and an amplitude modulation of the light reflected from the object during a pass of the frequency modulation from a first frequency to a second frequency.

14. The optical measuring device according to claim 13, wherein the evaluation circuit is configured to conduct a first Fourier transformation during the duration of the frequency of the amplitude modulation and a second Fourier transformation during a duration of the changed frequency of the amplitude modulation.

15. The optical measuring device according to claim 1, wherein the controllable optical modulator is designed for amplitude modulation of the frequency-modulated single-mode laser beam generated by the laser device, and wherein the frequency of the amplitude modulation resulting from a first modulation signal and a second modulation signal differing therefrom at least in frequency.

16. A method for measuring motor vehicles, comprising-the-step:
generating a frequency-modulated laser beam, in particular a single-mode laser beam;
decoupling of part of the frequency-modulated laser beam;
modulating an amplitude of the remaining frequency-modulated laser beam with an amplitude modulation signal;
receiving the part of the frequency-modulated laser beam and a reflected part of the amplitude- and frequency-modulated laser beam in such a way that a beat is generated from both parts;
detecting and evaluating of the beat at least in frequency space.

17. The method according to claim 16, wherein detecting comprises:
applying a complex Fourier transform to the detected signal; and
evaluating a phase length of a portion at a frequency corresponding to an amplitude modulation frequency of the amplitude modulation signal.

18. The method according to claim 16, wherein evaluating comprises generating a complex Fourier transform from the acquired signal, with a first frequency component which corresponds substantially to a frequency of the beat and a second frequency component which corresponds substantially to an amplitude modulation frequency of the amplitude modulation signal;
the method further comprising:
calculating a distance from the signal with the first frequency component and/or a phase position of the signal with the second frequency component;
calculating a relative velocity from the signal with the first frequency component on the basis of a phase position of the signal with the second frequency component.

19. The method according to claim 18, wherein the amplitude modulation frequency is selected to be greater than the first frequency component.

20. The method according to claim 16,
wherein a modulation frequency of the frequency-modulated laser beam increases from a first frequency value to a second frequency value linearly, during a period of time, and the period of time is greater than a predetermined value corresponding to a maximum measuring distance.

21. The method according to claim 20, wherein receiving and generating the beat is performed during the time period.

22. The method according to claim 16, further comprising:
deflecting the frequency- and amplitude-modulated laser beam by a defined amount at regular intervals, in particular at times when no reception is taking place; or
deflecting of the frequency- and amplitude-modulated laser beam in an essentially continuous manner.

23. The method according to claim 16, wherein a coherence length generated single-mode laser beam corresponds to at least twice a distance to an object reflecting the single-mode laser beam.

24. The method according to claim 16, wherein the amplitude modulation signal is composed of a first component having a first frequency and at least one second component having a second frequency different from the first frequency.
